(19) United States
(12) Patent Application Publication
(10) Pub. No.: US 2025/0185673 A1
(43) Pub. Date: Jun. 12, 2025

(54) METHOD FOR PREPARING A FRESH PIZZA DOUGH FOR FUTURE USE

(71) Applicant: CERELIA, LIEVIN (FR)

(72) Inventors: Elvire MARÉE, LILLE (FR); Claire MICHEAUX, Quesnoy-sur-Deule (FR)

(21) Appl. No.: 18/710,985

(22) PCT Filed: Nov. 16, 2022
(86) PCT No.: PCT/FR2022/052106

§ 371 Date: May 16, 2024

(30) Foreign Application Priority Data
Nov. 18, 2021 (FR) 2112196

(51) Int. Cl. A21D 10/02; A21D 8/02; A21D 13/41

(52) U.S. Cl. CPC A21D 10/025; A21D 8/02; A21D 13/41

(57) ABSTRACT

A method for preparing a pre-rolled fresh pizza dough, for future use, includes measuring out the ingredients; kneading; extruding the dough; dividing the dough; shaping with or without rounding, and packaging. The kneading step includes an initial phase of folding, or mixing the ingredients; a first phase of high-pressure kneading; a second phase of low-pressure kneading; and a third phase of high-pressure kneading.

The invention relates to a method for preparing a pre-stretched fresh pizza dough for future use, and more particularly, a method for preparing a pre-stretched fresh pizza dough, with a honeycombed structure, which is stable in storage for at least one month at refrigeration temperature, and makes it possible to obtain a cooked product of artisanal organoleptic quality.

Artisan pizza is a food product in high demand among consumers, for reasons of convenience, and owing to its taste and its texture, crispy-soft with heterogeneous honeycombing.

The quality of the heterogeneous honeycombing of the dough is generally linked to the artisanal kneading of the pizza dough. The industrial pre-stretched fresh pizza dough currently available has homogeneous honeycombing with a fine, regular consistency.

In the industrial preparation of dough, industrial kneading has sometimes been combined with pressure conditions to modify the quality of the dough. These experiments have mainly focused on bread dough.

Document EP 0 629 115 describes kneading in two stages, the first under pressure and the second under partial vacuum, to reduce the quantity of air in the dough. This two-stage kneading method results in a texture which is fine and regular like sandwich bread, something which does not at all correspond to the structure of artisan pizza, which is characterized by heterogeneous honeycombing.

Document JP 6 678 058 describes the kneading of bread dough, comprising two phases separated by a break of 5 minutes to 3 hours. The first phase relates to the kneading, at reduced pressure, of a pre-dough made of flour and water, which must then be completed by the addition of ingredients to arrive at the composition of the final dough. This first phase may be preceded by a step of kneading at normal pressure. The second phase relates to the kneading, after the addition of the bread-making ingredients, and at normal pressure, of the bread dough. This second phase may be followed by a step of kneading at reduced pressure, as in document EP 0 629 115.

Document WO 93/17561 describes a method for preparing bread dough comprising two phases. The first phase relates to mixing the bread-making ingredients. It takes place in two stages: a first stage of mixing at a pressure higher than normal, and a second stage of mixing at reduced pressure. The second phase relates to kneading at normal pressure. The concept of mixing differs from that of kneading in that the latter consists in developing the properties of the bread dough by hydrating the components and forming the visco-elastic network of gluten in particular, whereas the role of mixing is to homogenize the preparation.

One of the aims of the invention is to provide a pizza dough for future use, all the user having to do is add the toppings of their choice and cook the pizza before serving.

Another aim of the invention is to provide a pre-stretched fresh pizza dough, for future use, which is stored at refrigeration temperature, having the structural qualities of an artisan pizza.

Another aim of the invention is to provide a pre-stretched fresh pizza dough, for future use, having organoleptic qualities which are constant for at least 30 days.

The subject matter of the invention is a method for preparing a pre-stretched fresh pizza dough, for future use, the method not comprising any step at a temperature below or at the temperature referred to as the crystallization temperature, and comprising the steps of:
measuring out the ingredients;
kneading;
extruding the dough;
dividing the dough;
shaping with or without prior rounding; and
packaging,

characterized in that the kneading comprises an initial phase of folding, or mixing of the ingredients; a first phase of kneading at a high pressure of greater than 1 bar and of less than 3 bar, a second phase of kneading at a low pressure of less than 1 bar; a third phase of kneading at a high pressure of greater than 1 bar and of less than 3 bar; and in that the duration of kneading is between 1 and 4 minutes.

According to an embodiment, the first phase of kneading is carried out at a pressure of greater than 1 bar and of less than 2 bar, the second phase at a pressure of 0.3 bar, and the third phase at a pressure of greater than 1 bar and of less than 2 bar.

According to an embodiment, the duration of kneading is at most equal to 2 minutes.

According to an embodiment, each of the kneading phases has a duration of between 20 and 40 seconds.

According to an embodiment, the initial phase of folding has a duration of less than 60 seconds.

According to an embodiment, all of the steps of the method for preparing a pre-stretched fresh pizza dough take place at a temperature above the temperature referred to as the crystallization temperature.

According to an embodiment, the dough for future use is adapted to be stored for a period of at least 30 days, at refrigeration temperature, between 0 and 8° C.

According to an embodiment, the cut pizza dough is packaged under a dioxygen barrier film.

According to an embodiment, the shaped pizza dough is packaged under vacuum.

The invention relates to a method for preparing pre-stretched fresh pizza dough, with a honeycombed structure, which is stable in storage for at least one month at refrigeration temperature, and makes it possible to obtain a cooked product of artisanal organoleptic quality.

In the industrial method for preparing pizza dough according to the invention, the pizza dough is described as fresh because the method does not comprise any step below or at the temperature referred to as the crystallization temperature.

The temperature referred to as the crystallization temperature is the commercial freezing temperature, that is to say the temperature at which the first ice crystals form in the food product being frozen. This temperature depends on the water content of the food product, and the solute content of the water. This temperature is generally between −0.5° C. and −3° C.

The method for preparing a pre-stretched fresh pizza dough, which is ready to use after a period of storage at refrigeration temperature of at least 30 days, comprises the steps of:
measuring out the ingredients;
kneading;
extruding the dough;
dividing the dough;
shaping with or without prior rounding;
packaging.

The measuring out of the ingredients is performed in the conventional manner.

Kneading comprises several phases. In the initial phase of folding, the ingredients are hydrated and mixed, for a duration of less than 60 seconds.

In the first kneading phase, the dough being produced is subjected to a pressure of greater than 1 bar and of less than 3 bar, for example 1.5 bar, in the presence of air or gases such as CO2, N2 or O2, alone or as a mixture. During this first kneading phase, air (or gas) is incorporated into the dough, forming bubbles, and the density of the dough decreases.

In the second kneading phase, the dough is subjected to a pressure of less than 1 bar, for example 0.3 bar. The dough expands, which causes the gases in the dough to expand. The structure of the dough changes owing to the shearing action provided by kneading. The bubbles formed during the first kneading phase are divided by kneading. They become smaller and more numerous cells. The gluten mesh becomes finer and denser. The structure of the dough becomes fine and very homogeneous. It corresponds to the desired structure for sandwich bread.

In the third kneading phase, the dough is subjected to a pressure of greater than 1 bar and of less than 3 bar, for example 1.5 bar, in the presence of air or gases such as CO2, N2 or O2, alone or as a mixture. This results in movement of the cells and/or their expansion in the dough depending on the pressure gradients. The cells may join up and fuse, forming larger cavities, of heterogeneous size, typical of artisan products. The structure thus obtained is both heterogeneous and strong. The dough is fully developed and relaxed, requiring no extended resting time to work.

The total duration of kneading is between 1 and 4 minutes, and preferably less than 2 minutes. Each of the three kneading phases has a duration of between 20 and 40 seconds, preferably.

The following steps of the method have the purpose of maintaining this structure until the formation of the stretched pizza dough, and storage thereof until it is used by the consumer.

The extrusion of the dough is carried out in the conventional manner, such as the division of the dough into pieces of desired weight.

Rounding is preferably carried out in two successive steps of gentle gripping to form balls in which the tensions are uniformly distributed with the application of light pressure.

Shaping is preferably carried out using a press, which makes it possible to give the dough its shape, and to fix it in the raw state, without the use of freezing temperatures, which ensures that the dough has the quality of fresh pizza dough.

Rolling out and cutting to the desired shape are carried out in the conventional manner.

It is packaged under a dioxygen barrier film, under a modified atmosphere.

The steps of handling the dough after kneading are advantageously accompanied by the use of technological aids such as flour, semolina, or oil in order to facilitate mechanical treatment by helping the dough to slide on metal surfaces, and prevent it from sticking thereto.

The method for preparing pre-stretched fresh pizza dough for future use ensures that a dough of artisanal organoleptic quality is obtained. The structure of this dough is characterized by heterogeneous honeycombing, comprising both numerous fine bubbles and air pockets of various sizes, forming a stable and flexible whole. After cooking, this dough structure gives a texture that is both soft and crispy, with a perception of freshness.

The preparation method according to the invention is characterized in particular by the absence of freezing of the dough, which is kept fresh, at a refrigeration temperature of between 0 and 8° C. for its shelf life of at least 30 days, while offering the organoleptic properties of a fresh, artisan-quality product.

1. A method for preparing a pre-stretched fresh pizza dough, for future use, the method not comprising any step at a temperature below or at the temperature referred to as the crystallization temperature, and comprising the steps of:
measuring out the ingredients;
kneading;
extruding the dough;
dividing the dough;
shaping with or without rounding; and
packaging,
wherein the kneading comprises:
an initial phase of folding, or mixing of the ingredients;
a first phase of kneading at a high pressure of greater than 1 bar and of less than 3 bar;
a second phase of kneading at a low pressure of less than 1 bar;
a third phase of kneading at a high pressure of greater than 1 bar and of less than 3 bar;
and in that the duration of kneading is between 1 and 4 minutes.

2. The method as claimed in claim 1, wherein
the first phase of kneading is carried out at a pressure of greater than 1 bar and of less than 2 bar,
the second phase of kneading is carried out at a pressure of 0.3 bar, and
the third phase of kneading is carried out at a pressure of greater than 1 bar and of less than 2 bar.

3. The method as claimed in claim 1, wherein the duration of kneading is at most equal to 2 minutes.

4. The method as claimed in claim 3, wherein each of the three kneading phases has a duration of between 20 and 40 seconds.

5. The method as claimed in claim 3, wherein the initial phase of folding has a duration of less than 60 seconds.

6. The method as claimed in claim 1, wherein all of the steps of the method for preparing a pre-stretched fresh pizza dough take place at a temperature above the temperature referred to as the crystallization temperature.

7. The method as claimed in claim 1, wherein the dough for future use is adapted to be stored for a period of at least 30 days, at refrigeration temperature, between 0 and 8° C.

8. The method as claimed in claim 1, wherein the cut pizza dough is packaged under a dioxygen barrier film.

9. The method as claimed in claim 1, wherein the shaped pizza dough is packaged under vacuum.
